(19) United States
(12) Patent Application Publication
(10) Pub. No.: US 2009/0232137 A1
(43) Pub. Date: Sep. 17, 2009

(54) System and Method for Enhancing TCP Large Send and Large Receive Offload Performance

(75) Inventors: Jacob Cherian, Austin, TX (US); Gaurav Chawla, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 12/046,682

(22) Filed: Mar. 12, 2008

(51) Int. Cl. H04L 12/56

(52) U.S. Cl. 370/392

(57) ABSTRACT

A system and method for enhancing TCP large send and large receive offload performance are disclosed. A method may include: (a) receiving from a particular sender one or more incoming packets, each incoming packet having control information indicating a source node and a destination node for that packet; (b) determining the source node and the destination node of each incoming packet based on the control information of each packet; (c) determining a number of successive incoming packets that have the same source node and the same destination node; (d) determining whether the number of successive incoming packets having the same source node and the same destination node is greater than a predetermined minimum threshold; and (e) pausing transmission of packets from one or more senders other than the particular sender if the number of successive incoming packets having the same source node and destination node is greater than the predetermined minimum threshold.

### TECHNICAL FIELD

The present disclosure relates in general to network communication, and more particularly to a system and method for enhancing large send and large receive offload in a network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are often communicatively coupled via packet mode communication networks. In packet mode communication networks, data to be transmitted between two network end devices is often broken up into discrete blocks of data known as packets The packets are sent between the end devices are over data links shared with other network traffic. Typically, a packet consists of two portions: control information and data payload. The control information often provides information (e.g., source and destination addresses, error detection codes, and/or sequencing information) that a network requires to appropriately route and deliver the data payload and reconstruct the sent data from multiple packets at the receiver.

To perform packet mode communication, data to be communicated from an information handling system must be segmented into its respective packet data payloads, after which control information is added to the segmented data payloads. For example, according to the Open Systems Interconnection (OSI) Reference Model, a transport layer protocol (e.g., Transmission Control Protocol or TCP) may convert segmented data into TCP segments and each such segment includes control information that is used to reconstruct sent data. TCP control information may be in the form of sequence numbers that are used to reconstruct data in the case of out of order arrival of packets, and to detect and recover lost packets. A network layer protocol (e.g., Internet Protocol of IP) may then further encapsulate the TCP packet with an IP header. The IP header may include control information which specifies the functional and procedural means for transferring data from a source to its destination, including network address information. A data link layer protocol (e.g. Ethernet) may further encapsulate the network layer packet (e.g., IP packet) by adding control data known as a frame header and frame footer to create an Ethernet frame. Header and footer information may include control information providing the functional and procedural means to transfer data between network entities (e.g., network switches).

Historically, TCP segmentation of data was performed by software on an information handling system prior to communication of data to a network interface or network switch. However, as speed and performance of communication networks have increased, software-based segmentation has required greater processing resources. Such increased use of processing resources for segmentation may result in the reduction of processing resources left for applications running on the information handling system.

Accordingly, under newer approaches, segmentation of data has been offloaded to communications hardware, such as network interface cards, for example. One approach, known as LSO (for “large segment offload” or “large send offload”), is used to increase outbound data throughput of TCP packet mode networks and reduce processor overhead. In LSO, an operating system may assemble a buffer of data and send the data buffer to a network interface card (NIC) associated with an information handling system, along with TCP and IP control information for the first TCP segment that may be constructed from the data. The NIC may then segment the data into packets, add control information to the packets using control information provided by the operating system, and then transmit the resulting packets to the network.

Similarly, to increase inbound data throughput of packet mode networks, a related approach known as LRO (for “large receive offload”) operates to aggregate multiple incoming packets from a single data stream into a larger buffer before the buffer is communicated to its destination operating system, thus reducing the processing requirements of the destination node of the data stream. However, implementing LRO is often more challenging than LSO. Under LSO, a contiguous data stream is simply segmented into packets and header information is appended to each packet. However, in LRO, received packets can arrive in any order and from numerous sources, thus requiring more than simple concatenation of a received data stream. In addition, under traditional approaches, network switches interleave frames from multiple sources to the same output, which may lead to inefficiency of LRO. To provide efficiency for LRO when multiple streams are interleaved, the network adapter will need to implement large amounts of memory to buffer the incoming packets and reassemble the packets. However, providing such large amounts of memory and additional processing resources may increase costs and complexity of such approaches to LRO. Traditional approaches are particularly troublesome for storage devices, as multiple sources may attempt to write to a storage device, thus leaving to interleaving of frames and degradation of LRO.

Accordingly, a need has arisen for systems and methods that effectively implement LSO and LRO without the complexity and cost incumbent in traditional approaches.

### SUMMARY

In accordance with the teachings of the present disclosure, disadvantages and problems associated with implementing LRO may be substantially reduced or eliminated.

In accordance with one embodiment of the present disclosure, a method for enhancing TCP large send and large receive offload performance is provided. The method may include receiving from a particular sender one or more incoming packets, each incoming packet having control information indicating a source node and a destination node for that packet. The method may also include determining the source node and the destination node of each incoming packet based on the control information of each packet. The method may additionally include determining a number of successive incoming packets that have the same source node and the same destination node. The method may further include determining whether the number of successive incoming packets having the same source node and the same destination node is greater than a predetermined minimum threshold. Moreover, the method may include pausing transmission of packets from one or more senders other than the particular sender if the number of successive incoming packets having the same source node and destination node is greater than the predetermined minimum threshold.

In accordance with another embodiment of the present disclosure, a system for enhancing TCP large send and large receive offload performance may include a plurality of nodes communicatively coupled to each other and a switch communicatively coupled to the plurality of nodes. At least one node may be configured to segment a data stream into a plurality of packets, each packet having control information indicating a source node and a destination node for that packet. The switch may be configured to: (a) receive one or more incoming packets from a particular sender; (b) based on the control information of each incoming packet, determine the source node and the destination node of each incoming packet; (c) determine the number of successive incoming packets that have the same source node and the same destination node; (d) determine whether the number of successive incoming packets having the same source node and the same destination node is greater than a predetermined minimum threshold; and (e) if the number of successive incoming packets having the same source node and the same destination node is greater than a predetermined minimum threshold, pause receipt of packets from one or more senders other than the particular sender of the successive incoming packets having the same source node and destination node.

In accordance with a further embodiment of the present disclosure, a switch for enhancing TCP large send and large receive offload performance may include a plurality of input ports configured to receive one or more incoming packets, a plurality of output ports communicatively coupled to the plurality of input ports, and a controller communicatively coupled to the plurality of input ports and the plurality of output ports. Each packet may have control information indicating a source node and a destination node for that packet. The controller may be configured to: (a) based on the control information of each incoming packet, determine the source node and the destination node of such incoming packet; (b) determine the number of successive incoming packets that have the same source node and the same destination node; (c) determine whether the number of successive incoming packets having the same source node and the same destination node is greater than a predetermined minimum threshold; and (d) if the number of successive incoming packets having the same source node and the same destination node is greater than a predetermined minimum threshold, pause receipt of packets from one or more senders other than a particular sender of the successive incoming packets having the same source node and the same destination node.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for packet mode network communication, in accordance with an embodiment of the present disclosure;

FIG. 2 illustrates a flow chart of a method for implementing large receive offload at a network switch, in accordance with an embodiment of the present disclosure; and

FIG. 3 illustrates a flow chart of a method for implementing large receive offload at a network interface card, in accordance with an embodiment of the present disclosure.

### DETAILED DESCRIPTION

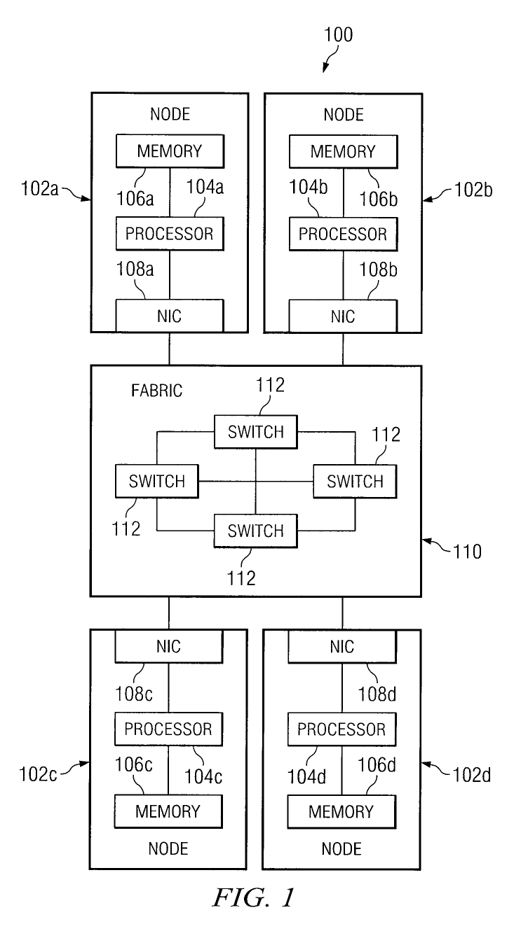

Preferred embodiments and their advantages are best understood by reference to FIGS. 1-3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example system 100 for packet mode network communication, in accordance with an embodiment of the present disclosure. As depicted, system 100 may include one or more nodes 102a-d (referred to generally herein as node 102 or nodes 102) and a fabric 110. Each node 102 may generally be operable to receive data from and/or transmit data to one or more other nodes 102 via fabric 110. One or more nodes 102 may comprise an information handling system and in certain embodiments, one or more nodes 102 may be a server. In the same or alternative embodiments, one or more nodes 102 may comprise a storage resource and/or other computer-readable media (e.g., a storage enclosure, hard-disk drive, tape drive, etc.) operable to store data. In other embodiments, one or more nodes 102 may comprise a peripheral device, such as a printer, sound card, speakers, monitor, keyboard, pointing device, microphone, scanner, and/or “dummy” terminal, for example. In addition, although system 100 is depicted as having four nodes 102, it is understood that system 100 may include any number of nodes 102.

As shown in FIG. 1, one or more nodes 102 may include a processor 104, a memory 106 communicatively coupled to processor 104, and a network interface card 108 communicatively coupled to processor 104.

Processor 104 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 104 may interpret and/or execute program instructions and/or process data stored in memory 106 and/or another component of node 102.

Memory 106 may be communicatively coupled to processor 104 and may comprise any system, device, or apparatus operable to retain program instructions or data for a period of time (e.g., computer-readable media). Memory 106 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to node 102 is turned off.

Network interface card (NIC) 108 may be any suitable system, apparatus, or device operable to serve as an interface between node 102 and fabric 110. NIC 108 may enable node 102 to communicate via fabric 110 using any suitable transmission protocol and/or standard. In certain embodiments, NIC 108 may provide physical access to a networking medium and/or provide a low-level addressing system (e.g., through the use of Media Access Control addresses). In certain embodiments, NIC 108 may include a buffer for storing packets received from fabric 110 and/or a controller configured to process packets received by NIC 108.

Fabric 110 may be a network and/or fabric configured to communicatively couple nodes 102 to one another. In certain embodiments, fabric 110 may include a communication infrastructure, which provides physical connections, and a management layer, which organizes the physical connections of nodes 102 and switches 112. Fabric 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Fabric 110 may transmit data using any storage and/or communication protocol, including without limitation, Fibre Channel, Frame Relay, Ethernet Asynchronous Transfer Mode (ATM), Internet protocol (IP), or other packet-based protocol, and/or any combination thereof. Fabric 110 and its various components may be implemented using hardware, software, or any combination thereof.

As depicted in FIG. 1, fabric 110 may include one or more switches 112. Each switch 112 may generally be operable to communicatively couple nodes 102 to each other, and may further be operable to inspect packets as they are received, determine the source and destination of each packet (e.g., by reference to a routing table), and forward each packet appropriately. One or more of switches 112 may include a plurality of input (or ingress) ports for receiving data, a plurality of output (or egress) ports for transmitting data, and a controller for inspecting received packets and routing the packets accordingly based on packet control information. Although FIG. 1 depicts fabric 110 comprising four switches 112, fabric 110 may include any number of switches.

In operation, system 100 may be utilized to implement large send offload (LSO) and large receive offload (LRO). For example, an operating system running on host 102a may assemble a data stream to be delivered to host 102b and deliver it, along with control information regarding the destination of the data, to NIC 108a. Implementing LSO, NIC 108a may segment the data stream into discrete data payloads, and append control information to each data payload to create packets. NIC 108a may communicate each of these packets to fabric 110. Implementing LRO using the methods described herein, a switch 112 of fabric 110 may reassemble all or a part of the data stream received from NIC 108a and forward it to NIC 108b. In turn, NIC 108b may also implement LRO using the methods described herein, for example, by reassembling all of a part of the data stream received from fabric 110.

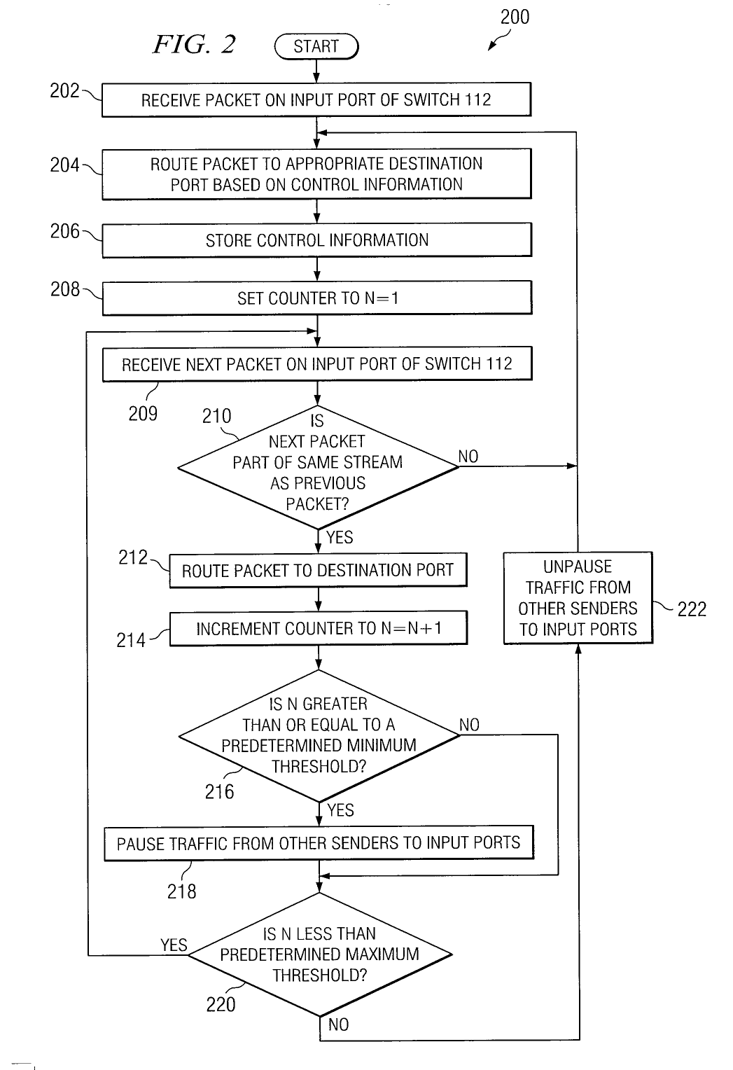

FIG. 2 illustrates a flow chart of a method 200 for implementing large receive offload (LRO) at a network switch 112, in accordance with an embodiment of the present disclosure. According to one embodiment, method 200 preferably begins at step 202. As noted above, teachings of the present disclosure may be implemented in a variety of configurations of system 100. As such, the preferred initialization point for method 200 and the order of the steps 202-222 comprising method 200 may depend on the implementation chosen.

At step 202, a switch 112 may receive a packet at its input port. Depending on the implementation, the packet may be a transport layer packet (e.g., Transmission Control Protocol (TCP) packet or User Datagram Protocol (UDP) packet), a network layer packet (e.g., Internet Protocol (IP) packet), a data link layer packet (e.g., Ethernet frame, Frame Relay frame or Token Ring frame), or any other suitable packet comprising a data payload and control information.

At step 204, switch 112 may route the packet to the appropriate destination port of switch 112 based on the packet's control information. For example, a controller or other component of switch 112 may read the header and/or footer information of the packet to determine the source and/or destination of the packet and route the packet to a destination port of switch 112 communicatively coupled to the particular destination node 102 of the packet. In an alternative embodiment, the packet may be stored in a buffer, memory or other computer-readable medium within switch 112 and may later be routed to the destination port of switch 112 along with other packets having similar control information.

At step 206, switch 112 may store the control information of the received packet for comparison with control information from later-received packets, as discussed in greater detail below. Switch 112 may store the control information in a memory or other computer-readable medium associated with switch 112.

At step 208, switch 112 may set a counter to a value of “1.” The counter may be implemented in a memory or other computer-readable medium associated with switch 112, and is generally operable to indicate the number of consecutive packets received at the input port that are part of the same data stream (e.g., the number of consecutive packets received at the input port having the same source, destination, and/or other similar or identical control information characteristics).

At step 209, switch 112 may receive another packet at its input port. At step 210, switch 112 may determine whether the incoming packet on the input port of switch 112 is part of the same data stream as the previous packet received at the input port at step 202. For example, a controller or another component of switch 112 may compare the control information of the next incoming packet with the control information of the previously-received packet stored at step 206. The comparison may include comparing the source of both packets, the destination of both packets, a sequence identification number of both packets, and/or other information within the control information of both packets.

If it is determined that the next incoming packet on the input port is part of the same data stream as the previously-received packet, method 200 may proceed to step 212. Otherwise, if it is determined that the next incoming packet on the input port is not part of the same data stream as the previously-received packet, method 200 may return to step 204.

At step 212, switch 112 may route the incoming packet to the appropriate destination port based on the control information stored at step 206 and/or the control information of the incoming packet, which should be similar or identical information. In an alternative embodiment, the packet may be stored in a buffer, memory or other computer-readable medium within switch 112 and may later be routed to the destination port of switch 112 along with other packets having similar control information.

At step 214, switch 112 may increment the counter by one, indicating that another consecutive packet from the same data stream has been received. At step 216, a controller or another component switch 112 may determine whether the counter value is greater than or equal to a predetermined minimum threshold value. The receipt of a number of consecutive packets from the same data stream (e.g., containing similar or identical control information) may indicate that other packets from the same data stream are likely to also arrive at the input port. Accordingly, if other packets from the same data stream are expected, it may be beneficial to perform actions (e.g., actions such as those described below with respect to step 218) to increase the likelihood of such packets being consecutively received and consecutively transmitted.

The predetermined minimum threshold value may be any positive integer number, and may be determined by experimentation. In certain embodiments, the predetermined minimum threshold value may be configured by a developer and/or manufacturer of switch 112. In the same or alternative embodiments, the predetermined minimum threshold value may be variably configurable by a network administrator and/or other user of switch 112.

If it is determined at step 216 that the counter value is greater than or equal to the predetermined minimum threshold value, method 200 may proceed to step 218. Otherwise, if it is determined that the counter value is less than the predetermined minimum threshold value, method 200 may proceed to step 220.

At step 218, a controller or another component of switch 112 may pause traffic from senders to the input ports of switch 112 other than the sender that sent the previous packet (e.g., by communicating a message to such senders to pause or cease transmission of data to switch 112). As mentioned above, if a number of consecutive packets from the same data stream are received by an input port, it may be likely that additional packets from the same data stream may be received. Accordingly, switch 112 may pause traffic from senders other than the sender of the last packet received, thus increasing the likelihood that the next packet received will be from the same source node 102. In certain embodiments, two or more switches 112 of fabric 110 may communicate with each other to ensure that all such switches 212 pause traffic from other senders other than the sender that sent the previous packet.

At step 220, a controller or another component of switch 112 may determine whether the counter value is greater than or equal to a predetermined maximum threshold value. In many network implementations, a NIC 108 receiving data from a switch 112 may be configured to buffer a maximum amount of packets. In addition, in certain embodiments of switch 112, switch 112 may include a buffer to hold a number of packets with similar control information, wherein such buffer may be communicated to the appropriate destination port once the buffer is full or if a packet from a different data stream is received by switch 112. The buffer may ensure that no packets are dropped from the point at which switch 112 detects a data stream coming in from one port and issues a request to pause on its other ports. In certain embodiments, the predetermined minimum threshold value may be configured by a developer and/or manufacturer of switch 112. In the same or alternative embodiments, the predetermined maximum threshold value may be variably configurable by a network administrator and/or other user of switch 112.

If it is determined at step 220 that the counter value is less than the predetermined maximum threshold value, method 200 may return to step 209. Otherwise, if it is determined that the counter value is equal to the predetermined minimum threshold value, method 200 may proceed to step 222.

At step 222, a controller or another component of switch 112 may un-pause traffic from senders to the input ports of switch 112 to allow all senders to send a packet to switch 112 (e.g., by communicating a message to such senders to resume transmission of data to switch 112). After completion of step 222, method 200 may return to step 204.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order. For example, in certain embodiments, steps 204-208 may execute in any order and/or substantially contemporaneously with each other. Method 200 may be implemented using system 100 or any other system operable to implement method 200. In certain embodiments, method 200 may be implemented partially or fully in software embodied in computer-readable media.

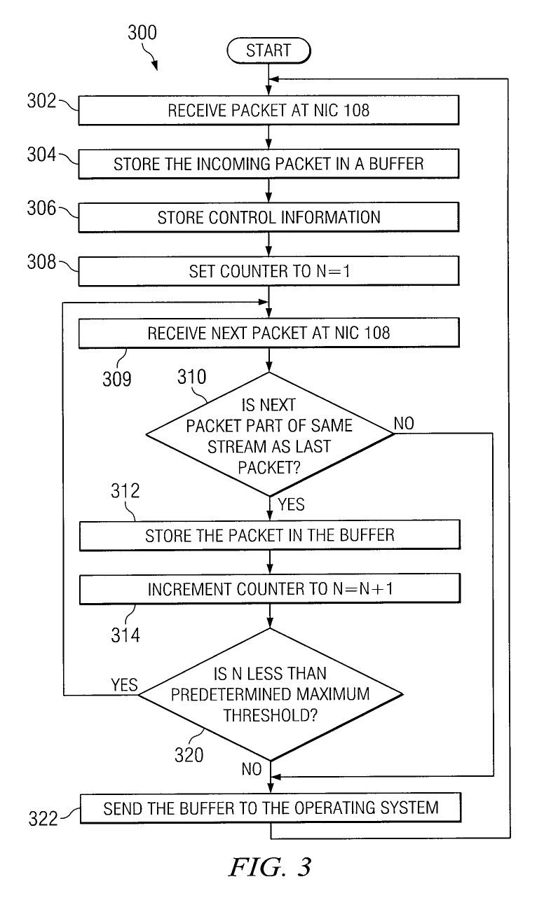

FIG. 3 illustrates a flow chart of a method for implementing LRO at a NIC 108, in accordance with an embodiment of the present disclosure. According to one embodiment, method 300 preferably begins at step 302. As noted above, teachings of the present disclosure may be implemented in a variety of configurations of system 100. As such, the preferred initialization point for method 300 and the order of the steps 302-322 comprising method 300 may depend on the implementation chosen.

At step 302, a NIC 108 may receive a packet from fabric 110. Depending on the implementation, the packet may be a transport layer packet (e.g., TCP packet or UDP packet), a network layer packet (e.g., IP packet), a data link layer packet (e.g., Ethernet frame, Frame Relay frame, or Token Ring frame), or any other suitable packet comprising a data payload and control information.

At step 304, NIC 108 may store the incoming packet in a buffer. The buffer may be implemented in a memory or other computer-readable medium associated with NIC 108, and may generally be operable to store one or more packets of a data stream.

At step 306, NIC 108 may store the control information of the stored packet for comparison with control information from later-received packets, as discussed in greater detail below. NIC 108 may store the control information in a memory or other computer-readable medium associated with NIC 108.

At step 308, NIC 108 may set a counter to a value of “1.” The counter may be implemented in a memory or other computer-readable medium associated with NIC 108, and is generally operable to indicate the number of consecutive packets received at NIC 108 that are part of the same data stream (e.g., the number of consecutive packets received at NIC 108 having the same source, destination, and/or other similar or identical control information characteristics.).

At step 309, switch 112 may receive another packet at its input port. At step 310, NIC 108 may determine whether the next incoming packet on NIC 108 is part of the same data stream as the packet previously received at NIC 108 at step 302. For example, a controller or another component of NIC 108 may compare the control information of the next incoming packet with the control information of the previously-received packet stored at step 306. The comparison may include comparing the source of both packets, the destination of both packets, a sequence identification number of both packets, and/or other information within the control information of both packets.

If it is determined that the next incoming packet to NIC 108 is part of the same data stream as the previously-received packet, method 300 may proceed to step 312. Otherwise, if it is determined that the next incoming packet on the input port is not part of the same data stream as the previously-received packet, method 300 may return to step 302.

At step 312, NIC 108 may store the incoming packet in the buffer along with other previously-received packets from the same data stream. At step 314, NIC 108 may increment the counter by one, indicating that another consecutive packet from the same data stream has been received.

At step 320, a controller or another component of NIC 108 may determine whether the counter value is greater than or equal to a predetermined maximum threshold value. As discussed above, a NIC 108 receiving data from a switch 112 may be configured to buffer a maximum amount of packets. Accordingly, while the receipt of many packets of the same data stream may be beneficial, there may be little benefit in receiving a number of packets greater than the buffer size of NIC 108. Consequently, the predetermined maximum threshold may be any positive integer value, and may be determined based on any number of factors, including without limitation, the maximum buffer size of NIC 108, and network bandwidth of fabric 110. In certain embodiments, the predetermined maximum threshold value may be configured by a developer and/or manufacturer of NIC 108. In the same or alternative embodiments, the predetermined maximum threshold value may be variably configurable by a network administrator and/or other user of NIC 108. If it is determined that the counter value is less than the predetermined maximum threshold value, method 300 may return to step 309. Otherwise, if it is determined that the counter value is equal to the predetermined minimum threshold value, method 300 may proceed to step 322.

When method 300 reaches step 322, one of two things may have happened: either NIC 108 has received a packet from a data stream other than that data stream currently stored in its buffer, or the counter has reached the maximum threshold value (potentially indicating the buffer is full). Accordingly, at step 322, NIC 108 may deliver the buffer to the operating system of its associated node 102. After completion of step 322, method 300 may return to step 302.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order. For example, in certain embodiments, steps 304-308 may execute in any order and/or substantially contemporaneously with each other. Method 300 may be implemented using system 100 or any other system operable to implement method 300. In certain embodiments, method 300 may be implemented partially or fully in software embodied in computer-readable media.

Although the present disclosure has been described in detail, it should be understood that various changes, substitutions, and alterations can be made hereto without departing from the spirit and the scope of the invention as defined by the appended claims.

What is claimed is:

1. A method for enhancing TCP large send and large receive offload performance comprising:
receiving from a particular sender one or more incoming packets, each incoming packet having control information indicating a source node and a destination node for that packet;
determining the source node and the destination node of each incoming packet based on the control information of each packet;
determining a number of successive incoming packets that have the same source node and the same destination node;
determining whether the number of successive incoming packets having the same source node and the same destination node is greater than a predetermined minimum threshold; and
if the number of successive incoming packets having the same source node and destination node is greater than the predetermined minimum threshold, pausing transmission of packets from one or more senders other than the particular sender.

2. A method according to claim 1, further comprising storing each successive incoming packet having the same source node and the same destination node in a buffer.

3. A method according to claim 2, further comprising:
determining whether the number of successive incoming packets having the same source node and the same destination node is less than a predetermined maximum threshold; and
if the number of successive incoming packets having the same source node and destination node is not less than the predetermined maximum threshold, transmitting the buffer to an output port of a switch.

4. A method according to claim 2, further comprising:
if one of the incoming packets does not have the same source node and the same destination node as the previously-received packet, transmitting the buffer to an output port of a switch.

5. A method according to claim 1, further comprising routing each successive incoming packet having the same source node and the same destination node from an input port of a switch to an output port of the switch.

6. A method according to claim 5, further comprising:
determining whether the number of successive incoming packets having the same source node and the same destination node is less than a predetermined maximum threshold; and
if the number of successive incoming packets having the same source node and the same destination node is not less than the predetermined maximum threshold, ceasing routing of successive incoming packets having the same source node and the same destination node from the input port of the switch to the output port of the switch.

7. A system for enhancing TCP large send and large receive offload performance comprising:
a plurality of nodes communicatively coupled to each other, wherein at least one node is configured to segment a data stream into a plurality of packets, each packet having control information indicating a source node and a destination node for that packet;
a switch communicatively coupled to the plurality of nodes, the switch configured to:
receive one or more incoming packets from a particular sender;
based on the control information of each incoming packet, determine the source node and the destination node of each incoming packet;
determine the number of successive incoming packets that have the same source node and the same destination node;
determine whether the number of successive incoming packets having the same source node and the same destination node is greater than a predetermined minimum threshold; and
if the number of successive incoming packets having the same source node and the same destination node is greater than a predetermined minimum threshold, pause receipt of packets from one or more senders other than the particular sender of the successive incoming packets having the same source node and destination node.

8. A system according to claim 7, the switch further configured to store each successive incoming packet having the same source node and the same destination node in a buffer.

9. A system according to claim 8, the switch further configured to:
determine whether the number of successive incoming packets having the same source node and the same destination node is less than a predetermined maximum threshold; and
if the number of successive incoming packets having the same source node and destination node is not less than the predetermined maximum threshold, transmit the buffer to an output port of the switch.

10. A system according to claim 8, the switch further configured to:
if one of the incoming packets does not have the same source node and the same destination node as the previously-received packet, transmit the buffer to an output port of the switch.

11. A system according to claim 7, the switch further configured to route each successive incoming packet having the same source node and the same destination node from an input port of the switch to an output port of the switch.

12. A system according to claim 11, the switch further configured to:
determine whether the number of successive incoming packets having the same source node and the same destination node is less than a predetermined maximum threshold; and
if the number of successive incoming packets having the same source node and the same destination node is not less than the predetermined maximum threshold, cease routing of successive incoming packets having the same source node and the same destination node from the input port of the switch to the output port of the switch.

13. A switch for enhancing TCP large send and large receive offload performance comprising:
a plurality of input ports configured to receive one or more incoming packets, each packet having control information indicating a source node and a destination node for that packet;
a plurality of output ports communicatively coupled to the plurality of input ports; and
a controller communicatively coupled to the plurality of input ports and the plurality of output ports, the controller configured to:
based on the control information of each incoming packet, determine the source node and the destination node of such incoming packet;
determine the number of successive incoming packets that have the same source node and the same destination node;
determine whether the number of successive incoming packets having the same source node and the same destination node is greater than a predetermined minimum threshold; and
if the number of successive incoming packets having the same source node and the same destination node is greater than a predetermined minimum threshold, pause receipt of packets from one or more senders other than a particular sender of the successive incoming packets having the same source node and the same destination node.

14. A switch according to claim 13, the controller further configured to store each successive incoming packet having the same source node and the same destination node in a buffer.

15. A switch according to claim 14, the controller further configured to:
determine whether the number of successive incoming packets having the same source node and the same destination node is less than a predetermined maximum threshold; and
if the number of successive incoming packets having the same source node and destination node is not less than the predetermined maximum threshold, transmit the buffer to one of the plurality of output ports.

16. A switch according to claim 14, the controller further configured to:
if one of the incoming packets does not have the same source node and the same destination node as the previously-received packet, transmit the buffer to one of the plurality of output ports.

17. A switch according to claim 13, the controller further configured to route each successive incoming packet having the same source node and the same destination node from an one of the plurality of input ports to one of the plurality of the output ports.

18. A switch according to claim 13, the controller further configured to:
determine whether the number of successive incoming packets having the same source node and the same destination node is less than a predetermined maximum threshold; and
if the number of successive incoming packets having the same source node and the same destination node is not less than the predetermined maximum threshold, cease routing of successive incoming packets having the same source node and the same destination node from one of the plurality of input ports to one of the plurality of the output ports
